(19) United States
(12) Patent Application Publication
(10) Pub. No.: US 2012/0140669 A1
(43) Pub. Date: Jun. 7, 2012

(54) METHOD AND ARRANGEMENT FOR TESTING OF A CAPACITY OF A COMMUNICATION NETWORK

(76) Inventors: Xiaoling Wang, >Älvsjö (SE); Franz Heiser, Jarfalla (SE); Peter Nordlund, Spanga (SE)

(21) Appl. No.: 13/390,306

(22) PCT Filed: Jun. 28, 2010
(86) PCT No.: PCT/SE10/50733

§ 371 Date: Feb. 13, 2012

Related U.S. Application Data
(60) Provisional application No. 61/238,148, filed on Aug. 29, 2009.

(51) Int. Cl. H04W 24/06

(52) U.S. Cl. 370/252

(57) ABSTRACT

A method in a communication network node for testing a capacity of a communication network comprising the communication network node is provided. The communication network node communicates with a plurality of user equipments on downlink and uplink channels over an air interface. The communication network node generates (201) artificial load in a traffic model converter unit comprised in the communication network node, using a traffic model. After reserving (202) a number of physical resource blocks to said generated artificial load, said traffic model converter unit in the communication network node sends (203) information about physical resources that are available for real user equipment load to a scheduler within the communication network node. The scheduler schedules (204) physical resource blocks for said real user equipment load.

### TECHNICAL FIELD

The present invention relates to a method and an arrangement in a communication network system and, more particular, to an arrangement allowing for testing of a capacity of a communication network system as well as a method for such testing.

### BACKGROUND

In a typical cellular radio system, also referred to as a wireless communication system, user equipments, also known as mobile terminals and/or wireless terminals communicate via a Radio Access Network (RAN) to one or more core networks. The user equipments may be mobile stations or user equipment units such as mobile telephones also known as “cellular” telephones, and laptops with wireless capability, e.g. mobile terminals, and thus may be, for example, portable, pocket, hand-held, computer-included, or car-mounted mobile devices which communicate voice and/or data with radio access network. The user equipments may also be referred to as terminals or UE:s.

The radio access network covers a geographical area which is divided into cell areas, with each cell area being served by a base station, e.g., a Radio Base Station (RBS), which in some networks is also called “eNB”, “eNodeB”, “NodeB” or “B node”. A cell is a geographical area where radio coverage is provided by the radio base station equipment at a base station site. The base stations communicate over the air interface operating on radio frequencies with the user equipments within range of the base stations. The communication from the base station to the user equipment is performed on DownLink (DL) and the communication from the user equipment to the base station is performed on UpLink (UL).

Long term Evolution (LTE) is a fourth generation mobile communication system after Global System for Mobile Communications (GSM), and Wideband Code Division Multiple Access (WCDMA).

In LTE systems, it is of critical importance for operators to know if the network can deal with increased usage of certain services before launching and promoting the services to subscribers. Such services may e.g. be conversational voice, conversational video, real time gaming, non-conversational video, IP Multimedia Subsystem (IMS) signalling, live streaming video, interactive gaming, buffered streaming video, etc. There is no active set concept in the LTE system, both the UL and the DL are orthogonal, making it fundamentally different from Universal Mobile Telecommunications System (UMTS) although the systems have a lot of similarities. An “active set” is a WCDMA term defined as the set of Node-Bs that the UE is simultaneously connected to. As Shannon's law indicates, the upper limits of theoretical throughput are reached and the only area where there is substantial scope for improvement of the throughput is inter-cell interference. Shannon's law, refers to a statement defining the theoretical maximum rate at which error-free digits can be transmitted over a bandwidth-limited channel in the presence of noise. c=b log₂ (1+s), wherein c is maximum achievable bitrate [bps], b is channel bandwidth [Hz], and s is signal-to-noise ratio [dB]. It is expected that site reuse and multiple antennas for e.g. GSM, UMTS and LTE on antenna frames will reduce the radio frequency (RF) design flexibility and in most cases only electrical tilt of antennas will be allowed. With these design constraints, there will be a need to use artificial load to generate interference within a cluster of sites to identify inherent design challenges, interfering cells, i.e. boomers, as well as interfered cells, i.e. victims. The artificial load generation gives the operators an opportunity during the pre-launch tuning phase to reduce inter-cell interference under loaded conditions. The tuning phase allows the markets to identify sites with substantial handicaps that will require azimuth or even antenna height changes.

Today, there exist two technologies for generating artificial load. In 3GPP, an Orthogonal Frequency Division Multiple Access (OFDMA) Channel Noise Generator (OCNG) specifies Physical Resource Block (PRB) allocations for artificial load. There is also a “faked UE” method, which simulates a real UE based on a traffic model.

However, with these existing methods, when testing how the network manages an increased load, it is difficult to compare different systems with each other since the load level on the air interface may differ between the tests. Further, it is hard to combine the OCNG based method and the “faked UE” based method. The “faked UE” based method is complex, in which the artificial load and the real UE load are mixed.

### SUMMARY

It is therefore an object of the invention to provide an improved way of testing the capacity of a communication network.

According to a first aspect, the object is achieved by a method in a communication network node for testing a capacity of a communication network comprising the communication network node. The communication network node communicates with a plurality of user equipments on downlink and uplink channels over an air interface. The communication network node generates artificial load in a traffic model converter unit comprised in the communication network node, using a traffic model. After reserving a number of physical resource blocks to said generated artificial load, said traffic model converter unit in the communication network node sends information about the physical resources that are available for scheduling of real user equipment load to a scheduler within the communication network node. The scheduler schedules physical resource blocks for said real user equipment load.

According to a second aspect, the object is achieved by an arrangement in a communication network node for testing a capacity of a communication network comprising the communication network node. The communication network node communicates with a plurality of user equipments on downlink and uplink channels over an air interface. The communication network node arrangement comprises a traffic model converter unit configured to generate artificial load by using a traffic model, to reserve a number of physical resource blocks to said generated artificial load and to send information about physical resources that are available for scheduling of real user equipment load to a scheduler within the communication network. The scheduler is configured to schedule physical resource blocks to said real user equipment load.

An advantage of the present solution is that a flexible method is introduced to generate artificial load in the air interface and in the scheduler.

A further advantage of the present solution is that the artificial load is predictable, i.e. it is possible to á priori know how much a certain artificial load will contribute to the load level in the system.

An advantage of the present solution is that the artificial load is not affecting the real load scheduler thus allowing to have functional development and/or capacity increase in the scheduler for real load almost independent of the artificial load.

Further advantages of the present solution is that it provides more simple scheduler design, less testing, clear separation of test functionality from real UE processing, independent roadmaps for scheduling and artificial load being possible, and artificial load may simulate future services and/or future scheduler behaviour, not yet available in the deployed product.

### BRIEF DESCRIPTION OF THE DRAWINGS

In the drawings, wherein like reference characters denote similar elements throughout the several views:

FIG. 1 is a block diagram that shows an example of an LTE communication network architecture;

FIG. 2 is a flowchart showing embodiments of a method for calculating PRB filler and PRB padding.

FIG. 3 is a schematic block diagram that shows embodiments of a communication network node.

FIG. 4 shows artificial load in the air interlace with PRB filler and PRB padding;

FIG. 5 is a diagram that shows artificial load in the air interface with PRB padding;

FIG. 6 is a diagram that shows artificial load in the air interface with PRB filler;

FIG. 7 is a schematic block diagram that shows embodiments of the present solution;

FIG. 8 is a schematic block diagram that shows embodiments of the present solution.

### DETAILED DESCRIPTION

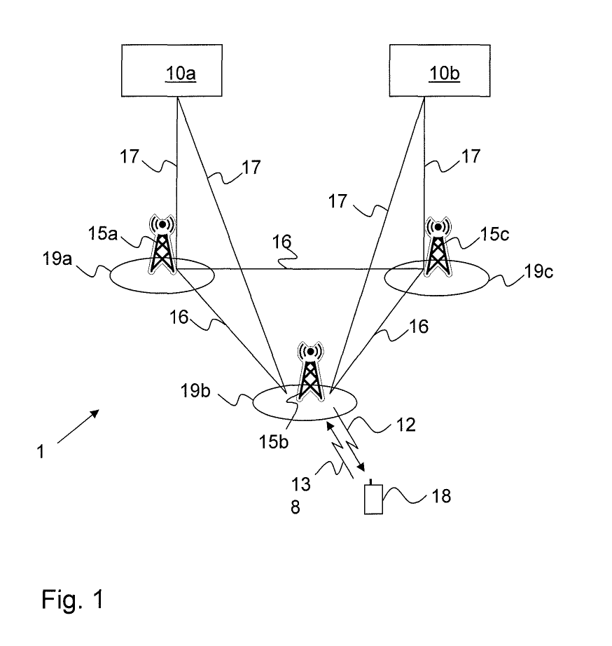

FIG. 1 depicts a communication network 1, including a radio access system or network (RAN) such as E-UTRAN, comprising at least one Radio Base Station (RBS), such as evolved Node B (eNB) 15a, 15b and 15c. The radio base station is also referred to as a communication network node 15a, 15b and 15c. The RAN is connected over an interface such as the S1-interface 17 to at least one Evolved Packet Core (EPC) network 10a and 10b, which is connected to external networks, not shown in FIG. 1, such as the Public Switched Telephone Network (PSTN) or the Integrated Services Digital Network (ISDN), and/or a connectionless external network such as the Internet. Each EPC 10a and 10b comprises e.g. a Mobility Management Entity (MME) which handles control signalling for instance for mobility.

The RAN provides communication and control for a plurality of User Equipments (UE) 18, only one shown in FIG. 1, and each one of eNB 15a, 15b and 15c is serving a respective at least one cell 19a, 19b and 19c through and in which the UEs 18 are moving. The eNBs 15a, 15b and 15c are communicating with each other over a communication interface 16, such as X2. Each of the UEs uses a respective downlink (DL) channel 12 and a respective uplink (UL) channel 13 to communicate with at least one 15a, 15b and 15c over a radio or air interface.

According to some embodiments of the present invention, the communication system is herein described as an LTE radio access network. The skilled person, however, realizes that the inventive method and arrangement work on other communications systems, such as e.g. GSM, WCDMA and CDMA2000 as well. Real load and artificial load may be separated in these systems by using time slots in GSM and spreading codes in WCDMA or CDMA2000 instead of physical resource blocks. The user equipments 18 may be mobile stations such as mobile telephones also called “cellular” telephones, and laptops with mobile termination and thus can be, for example, portable, pocket, hand-held, computer-included or car-mounted mobile devices which communicate voice and/or data with the RAN.

As described in the background section, it is important for operators to know if the network can deal with increased usage of certain services before launching and promoting the services to subscribers. Thus, artificial load is generated, either by using physical resource blocks (PRBs) according to OFDMA Channel Noise Generator (OCNG) or by simulating real UE load based on a traffic model. The use of artificial load gives the operators an opportunity during the pre-launch tuning phase to reduce inter-cell interference under loaded conditions. Embodiments of the present invention enable a combination of the OCNG load and the traffic model based load, which has not been possible before with existing methods where OCNG can only be used for OCNG artificial load and the “faked UE” can only be used for the traffic model based artificial load.

Embodiments of the present solution, enables an operator to test if a network manages an expected increased system load caused by introduction of new services to a plurality of subscribers prior to launching the services. Artificial load is generated in a traffic model converter unit within the eNB 15a, 15b or 15c. The eNB scheduler schedules real UE load. Artificial and real load is then transmitted on the downlink, while for the uplink artificial load is only allocated in the eNB 15a, 15b or 15c. This means that no artificial load is transmitted in uplink, however the eNB 15a, 15b or 15c has to handle the limited resource (PRB) availability.

By measuring artificial load as Physical Resource Block (PRB) load, embodiments of the present solution may both generate artificial load generated according to 3GPP OCNG and artificial load generated using a traffic model. The operator may specify a required minimal load level expressed as a percentage of the total PRBs. If specified, the mechanism ensures that at least the minimal load level is reached by padding PRBs up to this level. This is further described below. For OCNG type of artificial load the mechanism allows for generation of more load patterns than those prescribed by 3GPP while for the traffic model type of artificial load the mechanism provides reduced complexity while still allowing tests related to scheduling load and air interface load.

The scheduling resources are seen as PRB resources. Therefore, the artificial load in the scheduling is seen as the PRB load. The number of PRBs used for the artificial load is calculated based on configuration data. Configuration data is the parameter representation of the wanted traffic model for artificial load, see also table 1 below, such as e.g. QCI, resource type, priority, packet delay budget, packet error loss rate.

New concepts “PRB filler” and “PRB padding” are introduced by this feature to provide a flexible solution for the generation of artificial load in the eNB scheduling, and to load the eNB scheduler up to the required level.

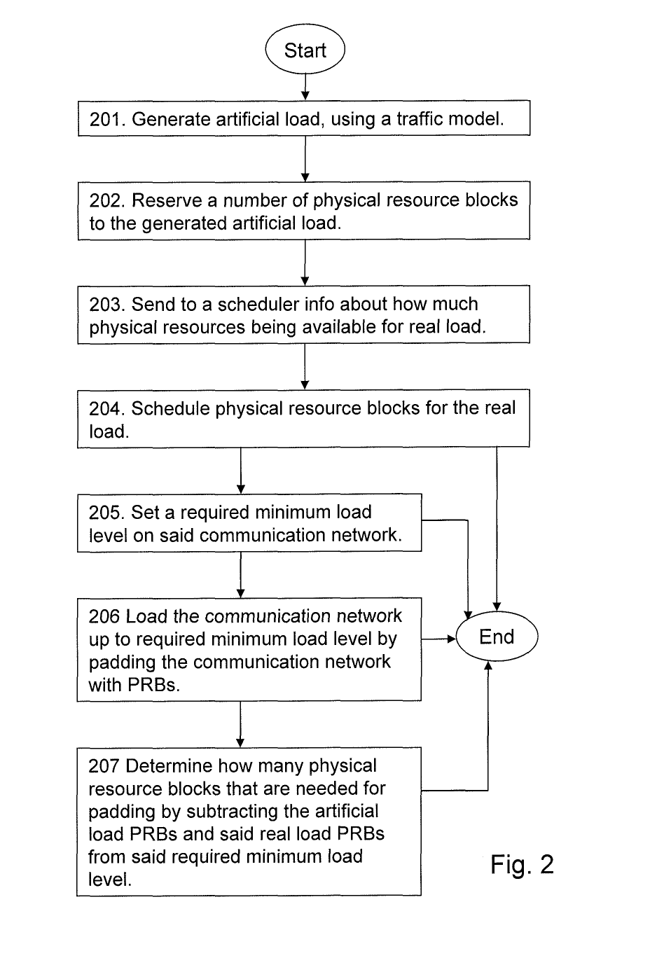

The present solution relating to a method in the communication network node 15a, 15b, 15c for testing a capacity of a communication network 1, according to some embodiments will now be described with reference to the flowchart depicted in FIG. 2. As mentioned above, the communication network node 15a, 15b, 15c is comprised in the communication network 1. The communication network node 15a, 15b, 15c communicates with a plurality of user equipments 18 on downlink and uplink channels over an air interface The method comprises the following actions, which actions may as well be carried out in another suitable order than described below if appropriate.

Action 201

To provide the generation of artificial load in the eNB scheduling according to the “PRB filler” concept, the communication network node 15a, 15b, 15c first generates artificial load, so called “filler”, in a traffic model converter unit comprised in the communication network node 15a, 15b, 15c, using a traffic model. The PRB filler concept is a way of providing a flexible solution for generation of artificial load in the eNB scheduling.

Action 202

The communication network node 15a, 15b, 15c then reserves a number of physical resource blocks, i.e. filler PRBs to said generated artificial load. It is the artificial load that is the PRB filler which may be estimated by using operator configuration. PRB filler is referred to as higher priority artificial load.

Action 203

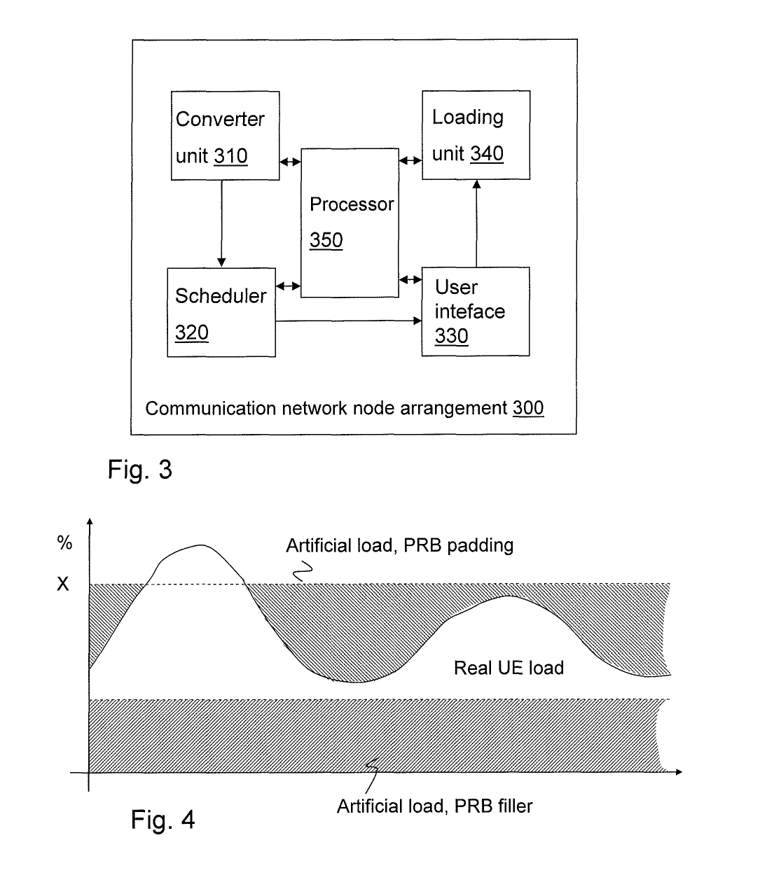

The traffic model converter unit sends information about the physical resources that are available for real user equipment 18 load, to a scheduler 320 within the communication network node 15a, 15b, 15c. The scheduler 320 is shown in FIG. 3 described below.

Action 204

The scheduler 320 schedules physical resource blocks for said real load.

Action 205

This is an optional step. To provide the loading of the scheduler of the system, up to the required level according to the “PRB padding” concept which is performed in some embodiments, the communication network node 15a, 15b, 15c sets a required minimal load level on said communication network 1. The configured minimal load, in some embodiments may be generated by operator configuration, and the real load of the user equipments 18 may together not reach the required minimal load level.

Action 206

This is an optional step. In the embodiments where action 205 is performed, the communication network node 15a, 15b, 15c may load said communication network up to said required minimal load level by padding the scheduler in said communication network with physical resource blocks.

Here the concept PRB padding is introduced. The PRB padding is the number of PRBs needed to fill up the scheduler of the system up to the required load level. These PRBs are artificial load.

Action 207

This is an optional step. In these embodiments the communication network node 15a, 15b, 15c may further determine the artificial physical resource blocks that are needed to pad said communication network up to said required minimal load level by subtracting said artificial load physical resource blocks and said real load related physical resource blocks from said required minimal load level.

In some embodiments the communication network node 15a, 15b, 15c may further determine said number of physical resource blocks reserved to said generated artificial load based on operator configuration. In these embodiments, this action may be performed by adding together a number of bitrates for different quality of service class identifiers, at different radio conditions, Single Input Multiple Output/Multiple Input Multiple Output (SIMO/MIMO) configuration and at different buffer status groups.

For example, when the scheduler schedules real user equipment load, the PRB filler will be excluded, i.e. it will be reserved, from the total available PRBs. After the allocation for the real user equipments 18 load is calculated, the traffic model converter unit 310 will verify if the PRB filler together with the PRBs for the real user equipment load has reached the required minimal load level. If not, the number of PRBs i.e. required load minus PRB filler minus PRBs for real UEs, will be added to ensure that the system is loaded to the required load level. This adding of PRBs is thus called PRB padding. PRB padding is referred to as lower priority artificial load. Compared to the real user equipment load, the PRB filler always has higher priority and PRB padding always has lower priority.

Accordingly, the calculation of PRB filler and PRB padding may be performed as the following example. X % is the required minimal load level. First, the PRB filler is calculated based on configuration data set by the operator. Then, the scheduler in the communication network node 15a, 15b, 15c schedules the real user equipment load, whereby available PRBs are the total PRBs minus the calculated PRB filler. Finally, the PRB padding is calculated as X % of the total PRBs minus the calculated PRB filler and minus the scheduled PRBs for real UEs.

To perform the method actions above for testing a capacity of a communication network 1, the communication network node 15a, 15b, 15c comprises an arrangement 300 depicted in FIG. 3. The term “configured to” may also be referred to as “arranged to”. As mentioned above, the communication network node 15a, 15b, 15c communicates with a plurality of user equipments 18 on downlink and uplink channels over an air interface.

The communication network node arrangement 300 comprises the traffic model converter unit 310 and a scheduler 320. The traffic model converter unit 310 is referred to as converter unit 310 in FIG. 3.

The traffic model converter unit 310 is configured to generate artificial load by using a traffic model, to reserve a number of physical resource blocks to said generated artificial load and to send information about how much resources that are available for real load to the scheduler 320.

Said scheduler 320 is configured to schedule physical resource blocks for said real load.

In some embodiments, said traffic model converter unit 310 is further configured to determine said number of physical resource blocks reserved to said generated artificial load based on operator configuration.

Said traffic model converter unit 310 may further be configured to determine said number of physical resource blocks reserved to said generated artificial load by adding together a number of bitrates for different quality of service class identifiers.

The communication network node arrangement 300 may further comprise a user interface 330 configured to be set to receive a required minimal load level to be applied for said communication network.

The communication network node arrangement 300 may further comprise a loading unit 340 configured to load said communication network up to said required minimal load level by padding said communication network with physical resource blocks.

In some embodiments, the loading unit 340 is further configured to determine how many physical resource blocks that are needed to load said communication network up to said required minimal load level, by subtracting said artificial load related physical resource blocks and said real load related physical resource blocks from said required minimal load level.

The present mechanism for testing a capacity of a communication network may be implemented through one or more processors, such as a processor 350 in the communication network node 15a, 15b, 15c, depicted in FIG. 3, together with computer program code for performing the functions of the present solution. The program code mentioned above may also be provided as a computer program product, for instance in the form of a data carrier carrying computer program code for performing the present solution when being loaded into the communication network node 15a, 15b, 15c. One such carrier may be in the form of a CD ROM disc. It is however feasible with other data carriers such as a memory stick. The computer program code can furthermore be provided as pure program code on a server and downloaded to the communication network node 15a, 15b, 15c remotely.

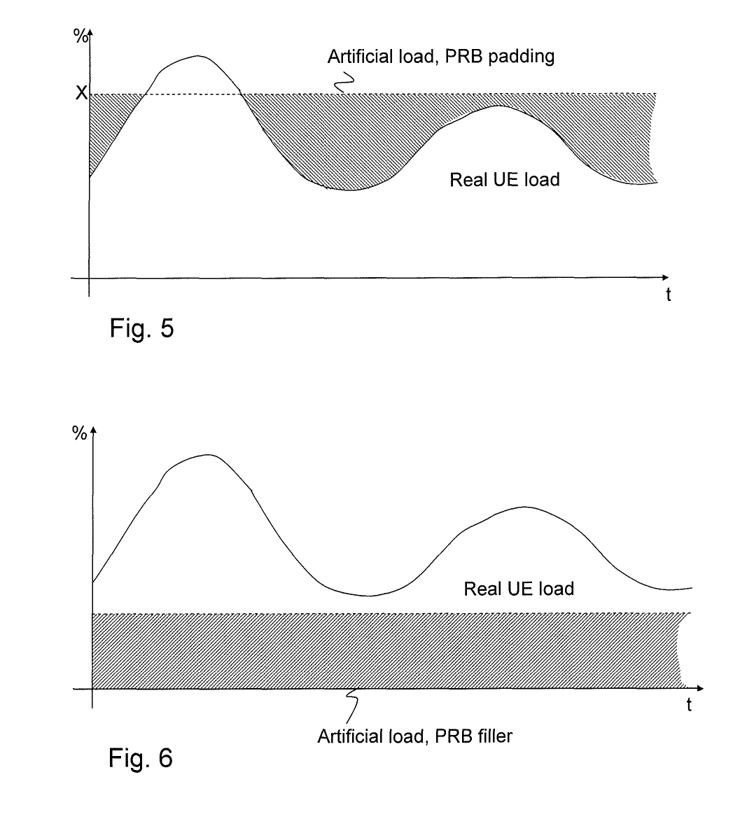

Diagrams in FIGS. 4-6 illustrates examples for filling+padding in FIG. 4; for padding only in FIG. 5 and for filling only in FIG. 6. In the respective diagrams, the x-axis refers to time and the y-axis refers to load.

FIG. 4 shows artificial load in the air interface, where PRB filler and PRB padding and the required minimal load level (X %) are defined. It is to be noted that the real UE load is not limited by the required minimal load level X %.

FIG. 5 shows artificial load in the air interface, where PRB padding and the required minimal load level (X %) are defined, but the PRB filler is not defined. It is to be noted that the real UE load is not limited to the required minimal load level X %.

FIG. 6 shows artificial load in the air interface, where PRB filler is defined but PRB padding and the required minimal load level (X %) are not defined.

PRB Filler

This is an example that refers to the performance of Action 201-204 described above. In some embodiments, downlink PRB filler for OCNG pattern based artificial load is used. The number of PRBs needed for the OCNG pattern based artificial load is specified by the operator configuration. So, for OCNG pattern based artificial load, the PRB filler is the number of PRBs specified by the operator configuration.

This is an alternative example referring to the performance of Action 201-204 described above. In the embodiments, downlink PRB filler for traffic model based artificial load is used. The PRB filler for the traffic model based artificial load is treated as constant with time. The number of bitrates for different quality of service (QoS) class identifiers (QCIs) are therefore added together to calculate the PRB filler size. The PRB filler size, i.e. the number of PRBs needed per modulation type for the PRB filler may be estimated from the total sum of the bitrates, i.e. based on the configuration. Which frequencies these should be allocated to, will randomly be generated per subframe.

To support the traffic model based air interface artificial load generation, an algorithm for configuring a static level of load but with variation with respect to frequency allocation may be used. The purpose of the algorithm is to provide a high priority load which is constant on a subframe basis with respect to the load level, to provide frequency allocation differentiation on a subframe basis, to consume PRBs for the scheduler and generate adequate interference on the downlink, and to consume PRBs for the scheduler on the uplink. The algorithm for the traffic model based air interface artificial load generation may hence be seen as a way to provide an alternative configuration for functionality otherwise very comparable to OCNG. Traffic model based configuration is a superior configuration compared to the very simple OCNG configuration and functionality. The main difference lies in the configuration for achieving a load with more realistic characteristics. For example, variations over subframes with respect to frequency allocation are achieved without manually configuring any random pattern for each cell but just by configuring a certain load in terms of number of users and QCI/signal to noise ratio (SINR) distribution.

The load, configured by the model may be derived from the following model specific input: QoS class identifier; number of users per QCI/SINR combination and/or a buffer status. I.e. the load may be derived from these parameters describing the traffic model. PRB filling may be derived from OCNG parameters.

The PRB filler may be estimated based on the number of bits needed per transmission time interval (TTI), SINR, modulation and coding scheme (MCS), transport block size (TBS), and/or the number of PRBs.

As mentioned above, the bitrates for different QoS class identifiers (QCIs) are therefore added together to calculate the PRB filler size. Each QCI may be mapped to an average required bit rate. The standardized QCIs of 1 to 9 are given default values regarding average required bit rate which are shown in Table 1 below. The example services do, however, span quite large intervals with respect to average required bit rate. Hence, the values will be configurable.

TABLE 1
Each QCI is mapped to an average required bit rate

| | | | | Packet | |
|---|---|---|---|---|---|
| | | | Packet | Error | |
| | | | Delay | Loss | |
| | Resource | | Budget | Rate | |
| QCI | Type | Priority | (NOTE 1) | (NOTE 2) | Example Services |
| 1 | GBR | 2 | 100 ms | 10⁻² | Conversational Voice |
| (NOTE 3) | | | | | |
| 2 | | 4 | 150 ms | 10⁻³ | Conversational Video (Live |
| (NOTE 3) | | | | | Streaming) |
| 3 | | 3 | 50 ms | 10⁻³ | Real Time Gaming |
| (NOTE 3) | | | | | |
| 4 | Non-GBR | 5 | 300 ms | 10⁻⁶ | Non-Conversational Video |
| (NOTE 3) | | | | | (Buffered Streaming) |
| 5 | | 1 | 100 ms | 10⁻⁶ | IMS Signalling |
| (NOTE 3) | | | | | |
| 6 | | 6 | 300 ms | 10⁻⁶ | Video (Buffered Streaming) |
| (NOTE 4) | | | | | TCP-based (e.g., www, e- |
| | | | | | mail, chat, ftp, p2p file |
| | | | | | sharing, progressive video, |
| | | | | | etc.) |
| 7 | | 7 | 100 ms | 10⁻³ | Voice, |
| (NOTE 3) | | | | | Video (Live Streaming) |
| | | | | | Interactive Gaming |
| 8 | | 8 | 300 ms | 10⁻⁶ | Video (Buffered Streaming) |
| (NOTE 5) | | | | | TCP-based (e.g., www, e- |
| | | | | | mail, chat, ftp, p2p file |
| | | | | | sharing, progressive video, |
| | | | | | etc.) |
| 9 | | 9 | | | |
| (NOTE 6) | | | | | |

Table 1 illustrates that different services are specified for artificial load generation using QCI.

GBR refers to Guaranteed Bit Rate, and TCP refers to Transmission Control Protocol. The notes in Table 1 are described below:

NOTE 1: A delay of 20 ms for the delay between a Policy and Charging Enforcement Function (PCEF) and a radio base station should be subtracted from a given Packet Delay Budget (PDB) to derive the packet delay budget that applies to the radio interface. This delay is the average between the case where the PCEF is located “close” to the radio base station (roughly 10 ms) and the case where the PCEF is located “far” from the radio base station, e.g. in case of roaming with home routed traffic (the one-way packet delay between Europe and the US west coast is roughly 50 ms). The average takes into account that roaming is a less typical scenario. It is expected that subtracting this average delay of 20 ms from a given PDB will lead to desired end-to-end performance in most typical cases. Also, note that the PDB defines an upper bound. Actual packet delays—in particular for GBR traffic—should typically be lower than the PDB specified for a QCI as long as the UE has sufficient radio channel quality.

NOTE 2: The rate of non congestion related packet losses that may occur between a radio base station and a PCEF should be regarded to be negligible. A Packet Error Loss Rate (PELR) value specified for a standardized QCI therefore applies completely to the radio interface between a UE and radio base station.

NOTE 3: This QCI is typically associated with an operator controlled service, i.e., a service where the Service Data Flow (SDF) aggregate's uplink/downlink packet filters are known at the point in time when the SDF aggregate is authorized. In case of E-UTRAN this is the point in time when a corresponding dedicated Evolved Packet System (EPS) bearer is established/modified.

NOTE 4: This QCI could be used for prioritization of specific services according to operator configuration.

NOTE 5: This QCI could be used for a dedicated “premium bearer” (e.g. associated with premium content) for any subscriber/subscriber group. Also in this case, the SDF aggregate's uplink/downlink packet filters are known at the point in time when the SDF aggregate is authorized. Alternatively, this QCI could be used for the default bearer of a UE/Packet Data Network (PDN) for “premium subscribers”.

NOTE 6: This QCI is typically used for the default bearer of a UE/PDN for non privileged subscribers. Note that Aggregated Maximum Bit Rate (AMBR) can be used as a “tool” to provide subscriber differentiation between subscriber groups connected to the same PDN with the same QCI on the default bearer.

The number of bits needed per TTI. The packet size and packet inter arrival time of the typical service associated with each QCI are used to calculate an average bitrate for each QCI. Typical packet size and packet inter arrival time for different QCI are defined in 3GPP in “LTE physical layer framework for performance verification”.

Some other factors will affect number of bits needed for every TTI:
Number of users per SINR class and per QCI, which is configured by the operator. The number of bits will be increased by number of users.
Buffer status, which is configured by operator. The buffer status only affect the best effort services, i.e. QCI 5-9, which then are all of non-GBR type. Full buffers and half full buffers are supported. Half full buffers are then only modelled by reducing the average required bit rate for the affected services by 50%. The same behaviour may be achieved by explicitly reducing the average required bit rate for QCI 5-9 with the same percentage.
Multiple input multiple output (MIMO). Reducing the packet size. For example 2×2 MIMO needs two transport blocks (TBs) for the downlink. The packet size will be reduced by 2.

So, total bits needed for each TTI and SINR is

Total bits needed per SINR=Sum(meanPacketSize/InterArrivalTime*nrOfUser(QCI,SINR))/BufferStatus/nrofTransportBlocks

SINR, MCS and TBS. Three different SINR levels are used and are denoted low, medium and high. These SINR levels may be mapped directly to MCS Index 0, 14, and 28 respectively. The low and high SINR level would hence correspond to the lowest and highest applicable MCS index in the Modulation and TBS index table for the Physical Downlink Shared Channel (PDSCH) specified by 3GPP in TS 36.213.

From that table a modulation order of 2, 4, and 6, realized by quadrature phase shift keying (QPSK), 16 quadrature amplitude modulations (QAM), and 64QAM, as well as a Transport Block Size (TBS) index for each MCS index may be read out. As a result, only three rows in the rather large TBS table specified by 3GPP in TS 36.213 will be utilized by this algorithm, namely the ones applicable to TBS Index 0, 13, and 26. Wherein 0=lowest TBS per allocated #PRB; 26 highest TBS per allocated #PRB 13=average. It may also be any similar combination with numbers between 0 and 26: 2, 14, 25 etc. See the examples below:

Low SINR:

Mapped to MCS Index=0, corresponding to MCS=QPSK and TBS Index=0

Middle SINR:

Mapped to MCS Index=14, corresponding to MCS=16QAM and TBS Index=13

High SINR:

Mapped to MCS Index=28, corresponding to MCS=64QAM and TBS Index=26.

A simple table may be created in the eNB, i.e. the a communication network node (5a, 15b, 15c), as exemplified in Table 2. As an example the bandwidth=10 MHz is used. Specific figures may be different in a real system.

TABLE 2
Transport block size table (bandwidth = 10 MHz)

| | Number of PRBs | | |
|---|---|---|---|
| SINR | 1 | . . . | 50 |
| Low | 16 | . . . | 1384 |
| Middle | 256 | . . . | 14112 |
| High | 712 | . . . | 36696 |

The complete table for TBS 0, 13, 26 is found in 3GPP 36.213 table 7.1.7.2.1-1.

When the number of bits needed per TTI has been calculated, the suitable transport block size can be found in Table 2. For example to find 300 bits at high SINR: Scan along TB size table in 3GPP at TBS 13 until TBS in table >300 bits. This will be 488 bits. From the table follows that 2 PRB will be needed for this.

The corresponding number of PRBs may also be found in Table 2.

DL PRB Padding

This refers to the Action 206 and 207 described above. If the sum of the PRB filler and real user equipment load is lower than the operator required load level X % of the total PRBs, corresponding to an associated PRB utilization, PRB padding is needed.

PRB padding=total PRB*X %−PRB filler−real UE PRBs

In which PRB padding starts is blockwise randomly generated. The modulation type for the padding is configurable.

Artificial User Data in DL for PRB Filler and PRB Padding

The random user data is generated in eNB, i.e. in the communication network node 15a, 15b and 15c. It will be transmitted in the allocated artificial PRBs, which is PRB filler+PRB padding.

It has already been described that the scheduling of the artificial users is greatly simplified. The artificial user equipments are scheduled according to their SINR levels before the real user equipments 18 are being scheduled. The real user equipments being scheduled are not handled by this algorithm.

The PRB selection may be performed either truly randomly or in a random like fashion. The PRB selection may further be performed either continuously on a subframe basis or according to a subframe pattern repeated for e.g., every frame. Given the two possibilities for each of these two issues there are four different alternative implementations.

Even though all four alternatives are applicable in a sense, implementation benefits from utilizing a subframe pattern which is repeated every frame, in the same way as for the OCNG implementation, may talk in favour of that alternative. Especially if a pattern is repeated every frame, there may be advantages of not utilizing a truly random PRB selection for each subframe. Instead a random like selection, assuring an appropriate spreading over the different frequencies, may be preferred to avoid that certain frequencies are always loaded and others are never loaded.

On the other hand, if a subframe pattern repeated every frame is not preferred from an implementation point of view, the PRBs may as well be just randomly selected from subframe to subframe no matter the frame boarders.

Link Adaptation

The true link adaptation carried out for the real users is based on the true number of resource elements (REs) per physical resource block. Hence, everything impacting the effective number of REs for a certain PRB is taken into account when a transport block size (TBS) is selected based on a calculated MCS for a certain number of PRBs.

For the artificial user equipments the link adaptation functionality will in addition to being simplified also be reversed in a sense. The effective number of REs for each PRB will not be evaluated but the required number of PRBs will instead be selected from a required TBS per subframe to support the service. The simplification/approximation made when going backwards from TBS and MCS directly to number of PRBs by means of the transport block size table can be motivated by the approximate input of the SINR level.

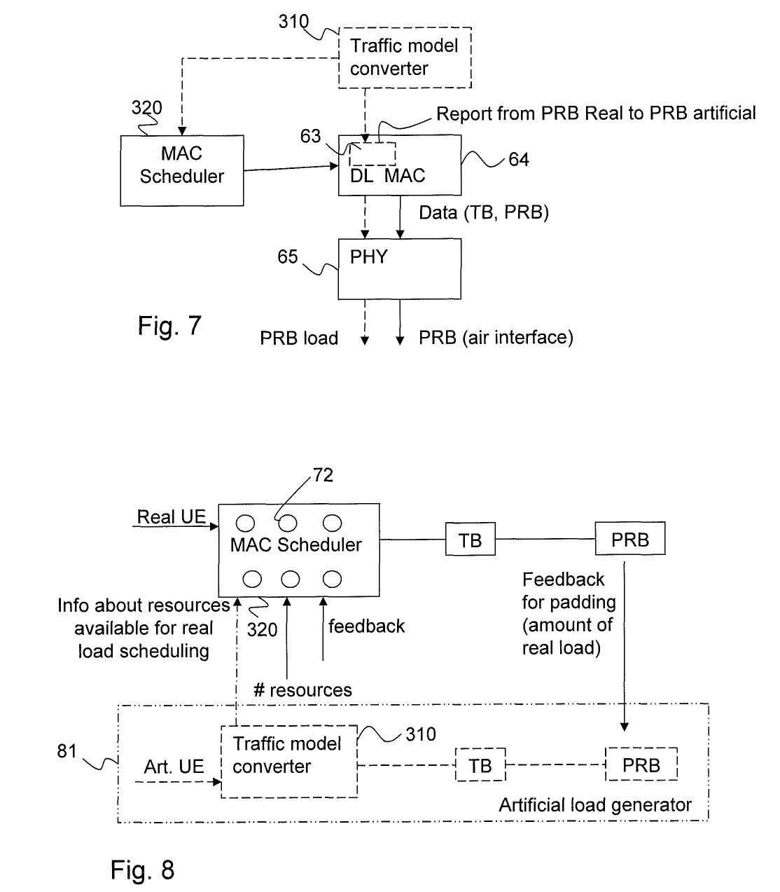

In FIG. 7, the artificial load is illustrated with dashed arrows and the real user equipment load is illustrated with solid arrows. Thus, the scheduler 320 in the eNB, i.e. in the communication network node 15a, 15b and 15c, schedules real user equipment load as physical resource blocks (PRBs) in the media access control (MAC) L1 layer. To generate the artificial load, the communication network node 15a, 15b and 15c comprises a traffic model converter unit 310 configured to generate artificial load and to send information to the scheduler 320 about resources that are available for real user equipment load. The rectangle 63 illustrates that a report is sent from the PRB real load to the PRB artificial load. The scheduled real load may be sent via the MAC layer 64 as data, carried in Transport Blocks TB and PRB, and via the network's physical layer 65 to the air interface. Also the artificial load is sent to the air interface via the MAC layer 64 and the physical layer 65.

FIG. 8 shows a scheduler according to embodiments of the present invention. In the scheduler 320 real load resources are scheduled. Artificial load is generated in an artificial load generator 81, and more specifically in a traffic model converter 310. Information about resources available for real load scheduling is sent from the traffic model converter 310 to the scheduler 320. Also feedback from the scheduler to the artificial load generator is sent for PRB padding. In FIG. 8, the arrow to the MAC Scheduler denoted “feedback” means in this context “real load feedback from MS and measurements in Node B”. The MAC Scheduler 320 determines TB (transport block size), PRB, and also MCS.

The main advantages of the invention are that a flexible method is introduced to generate artificial load in the air interface up to a determined load level (required minimal load level). Further, a flexible method is provided to generate either or both of the OCNG pattern based and traffic model based load. Still further a simple/flexible baseband architecture is introduced to separate real traffic and test traffic. OCNG based load and traffic model based load are enabled at the same time, e.g OCNG for PRB filling and traffic model for PRB padding.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural and vice versa.

Numerals included within parentheses in the accompanying claims are intended to assist understanding of the claims and should not be construed in any way to limit subject matter claimed by these claims.

1. A method in a communication network node for testing a capacity of a communication network comprising the communication network node, which communication network node communicates with a plurality of user equipments on downlink and uplink channels over an air interface, the method comprising:
generating an artificial load in a traffic model converter unit comprised in the communication network node, using a traffic model;
reserving a number of physical resource blocks to said generated artificial load;
sending, from said traffic converter unit to a scheduler within the communication network node, information about the physical resources that are available for scheduling of real user equipment load; and
scheduling, by the scheduler, physical resource blocks for said real user equipment load.

2. A method according to claim 1, the method further comprising:
setting a required minimal load level on said communication network.

3. A method according to claim 2, the method further comprising:
loading said communication network up to said required minimal load level by padding the scheduler in said communication network with physical resource blocks.

4. A method according to claim 3, the method further comprising:
determining how many physical resource blocks that are needed to pad said communication network up to said required minimal load level, by subtracting said artificial load related physical resource blocks and said real load related physical resource blocks from said required minimal load level.

5. A method according to claim 1, further comprising:
determining said number of physical resource blocks reserved to said generated artificial load responsive to a received operator configuration.

6. A method according to claim 1, wherein the reserving the number of physical resource blocks to said generated artificial load is performed by adding together a number of bitrates for different quality of service class identifiers.

7. An arrangement in a communication network node for testing a capacity of a communication network comprising the communication network node, which communication network node communicates with a plurality of user equipments on downlink and uplink channels over an air interface, the communication network node arrangement comprises:
a scheduler; and
a traffic model converter unit configured to generate an artificial load in response to a traffic model, to reserve a number of physical resource blocks to said generated artificial load and to send information about physical resources that are available for scheduling of a real user equipment load to said scheduler,
wherein said scheduler is configured to schedule physical resource blocks for said real user equipment load.

8. A communication network node arrangement according to claim 7, further comprising a user interface configured to be set to receive a required minimal load level on said communication network.

9. A communication network node arrangement according to claim 8, wherein the communication network node arrangement further comprises:
a loading unit configured to load said communication network up to said required minimal load level by padding the scheduler in said communication network with physical resource blocks.

10. A communication network node arrangement according to claim 9, wherein:
said loading unit is further configured to determine how many physical resource blocks are needed to pad said communication network up to said required minimal load level, by subtracting said artificial load related physical resource blocks and said real load related physical resource blocks from said required minimal load level.

11. A communication network node arrangement according to claim 7, wherein:
said traffic model converter unit is further configured to determine said number of physical resource blocks reserved to said generated artificial load responsive to a received operator configuration.

12. A communication network node arrangement according to claim 7, wherein:
said traffic model converter unit is further configured to determine said number of physical resource blocks reserved to said generated artificial load by adding together a number of bitrates for different quality of service class identifiers.
